(19) United States
(12) Patent Application Publication
(10) Pub. No.: US 2014/0059360 A1
(43) Pub. Date: Feb. 27, 2014

(54) POWER SUPPLIES MANAGEMENT IN AN ANALYTE DEVICE HAVING PRIMARY AND SECONDARY BATTERIES

(71) Applicants: Brian GUTHRIE, Inverness (GB); David Elder, Inverness (GB)

(72) Inventors: Brian GUTHRIE, Inverness (GB); David Elder, Inverness (GB)

(73) Assignee: LifeScan Scotland Limited, Inverness (GB)

(21) Appl. No.: 13/592,674

(22) Filed: Aug. 23, 2012

(51) Int. Cl. G06F 1/26

(52) U.S. Cl. 713/300

(57) ABSTRACT

Described herein are systems and methods (including system and method) to allow users of analyte monitors to continue to perform analyte measurement tests by using a secondary battery when the main battery is exhausted. By using applicants' technique, the monitor can be used for twice as long as compared to a monitor that only relies on a single battery as the only power supply. Moreover, applicants have devised systems and methods to indicate to the user which of the primary and secondary batteries should be replaced without disrupting the utilization of the monitor.

### BACKGROUND

Biosensors such as a glucose sensor (strip type and continuous monitoring type), electrocardiogram, blood pressure, and the like use batteries in its controllers or monitors. The batteries can be in the form of rechargeable or disposable batteries. The batteries are usually monitored to ensure that there is sufficient power to complete many of the tasks assigned to the sensors. In some of the monitors, the battery powering a backlight is the same battery powering the monitor. Where there is excessive usage of the backlight, the number of tests that the monitor can conduct is diminished for the user. As such, a separate battery is provided to power the backlight separately from the main battery that powers the monitor.

### SUMMARY OF THE DISCLOSURE

Applicants have devised a technique (including systems and methods) to allow users of analyte monitors to continue to perform analyte measurement tests by using a secondary battery when the main battery is exhausted. By using applicants' technique, the monitor can be used for twice as long as compared to a monitor that relies on a single battery as the only power supply. Moreover, applicants have devised systems and methods to indicate to the user which of the primary and secondary batteries should be replaced without disrupting the utilization of the monitor.

In one aspect, a method of managing power supplies in a portable analyte measurement device having a microprocessor coupled to a memory, the device including a primary battery and a secondary battery with the primary battery coupled to the microprocessor to power the microprocessor, the method comprising the steps of: evaluating with the microprocessor whether a measured capacity of the primary battery is greater than a first threshold; in the event the evaluating step returns an indication that the measured capacity of the primary battery is less than the first threshold, ascertaining whether a capacity of the primary battery is greater than a second threshold; in the event the ascertaining step returns an indication that the measured capacity of the primary is less than the second threshold, querying whether a measured capacity of the secondary battery is greater than the second threshold; and in the event the ascertaining step returns an indication that the measured capacity of the secondary battery is greater than the second threshold, then connecting the secondary battery to the microprocessor to power the microprocessor.

In another aspect, an analyte measurement system is provided that includes a biosensor unit and a portable physiological monitor unit. The biosensor unit that receives a physiological fluid of a use to allow for determination of an analyte in the fluid. The portable physiological monitor unit includes a microprocessor in communication with the biosensor unit to receive a plurality of analyte measurements reflective of a health condition of the user. The microprocessor is coupled to a memory and at least one of a primary and secondary batteries and configured to: measure a capacity of the primary battery and if the measured capacity is less than a first threshold then evaluate a capacity of the primary battery with respect to a second threshold; annunciate a low battery condition if there is an indication that the measured capacity of the primary battery is greater than or equal to the second threshold; evaluate the capacity of the secondary battery with respect to the secondary threshold and if there is an indication that the measured capacity of the primary is less than the second threshold then prevent usage of the unit otherwise if there is an indication that the measured capacity of the secondary battery is greater than the second threshold then the secondary battery is connected to the microprocessor to power the microprocessor; measure a capacity of the secondary battery; determine whether a measured capacity of the secondary battery is greater than a third threshold; prevent a connection of the backlight to the secondary battery if there is an indication that the measured capacity of the secondary battery is less than the third threshold; evaluate whether the measured capacity of the secondary battery is greater than a fourth threshold if there is an indication that the measured capacity of the secondary battery is greater than the third threshold; and annunciate that the capacity of the secondary battery is low if there is an indication that the measured capacity of the secondary battery is less than the fourth threshold.

In each of the aspects described above, the following features may be utilized separately or together with each these aforementioned aspects. For example, the measured capacity of the primary or secondary battery may be by measuring a voltage of the primary or secondary battery; the connecting may be by disconnecting the primary battery from the microprocessor; the connecting may be by annunciating that the primary battery is low on power; the annunciating may be by notifying that the device is on secondary or backup power; the device is suspended from further operation whenever the ascertaining step returns an indication that the voltage of the secondary battery is less than the secondary threshold; the secondary battery may be a battery for a backlight of a display of the measurement device; the first threshold may be from about 80% of at least one of a rated voltage or rated amperage of the primary battery; the second threshold may be any value of about 60% to about 79% of at least one of a rated voltage or rated amperage of the primary battery.

In the aspects above, the following steps may also be utilized, such as, measuring a capacity of the secondary battery; determining whether a measured capacity of the secondary battery from the measuring step is greater than a third threshold; in the event the determining step returns an indication that the measured capacity of the secondary battery is less than the third threshold, preventing connection of the backlight to the secondary battery; in the event the determining step returns an indication that the measured capacity of the secondary battery is greater than the third threshold, evaluating whether the measured capacity of the secondary battery is greater than a fourth threshold; and in the event the evaluating step returns an indication that the measured capacity of the secondary battery is less than the fourth threshold then annunciating that the capacity of the secondary battery is low.

These and other embodiments, features and advantages will become apparent to those skilled in the art when taken with reference to the following more detailed description of various exemplary embodiments of the invention in conjunction with the accompanying drawings that are first briefly described.

### BRIEF DESCRIPTION OF THE FIGURES

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates a chronic disease management system that includes an analyte measurement and data management unit and a biosensor.

FIG. 1B illustrates, in simplified schematic, an exemplary circuit board of a chronic disease data management unit.

FIG. 1C illustrates in schematic form a circuit that controls the utilization of the primary and secondary batteries in the unit of FIG. 1A.

FIG. 2 illustrates a process in which the system determines when to switch from a primary battery to a secondary battery.

FIG. 3 illustrates a process in which the system determines when to allow for a power drain (e.g., a backlight) to occur on the secondary battery.

FIGS. 4A and 4B illustrate icons representing the capacities of respectively the primary and secondary batteries. When these icons are flashing, such flashing indicates that the battery is close to exhaustion.

FIGS. 4C and 4D illustrate alternative icons representing the capacities of respectively the primary and secondary batteries. When these icons are flashing, such flashing indicates that the battery is close to exhaustion.

FIG. 4E illustrates how one icon can be used to represent the two respective batteries.

FIG. 4F illustrates yet how a single icon can be used to represent the two respective batteries.

FIG. 4G illustrates a display screen in which the icons can be utilized for the device of FIG. 1A.

### MODES OF CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. In addition, as used herein, the terms “patient,” “host,” “user,” and “subject” refer to any human or animal subject and are not intended to limit the systems or methods to human use, although use of the subject invention in a human patient represents a preferred embodiment.

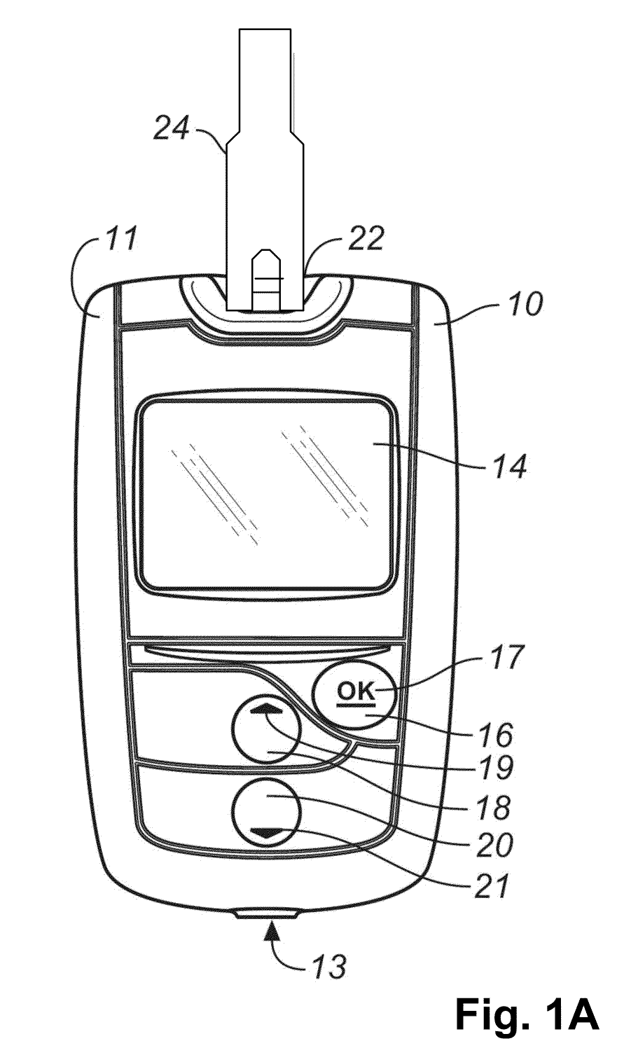

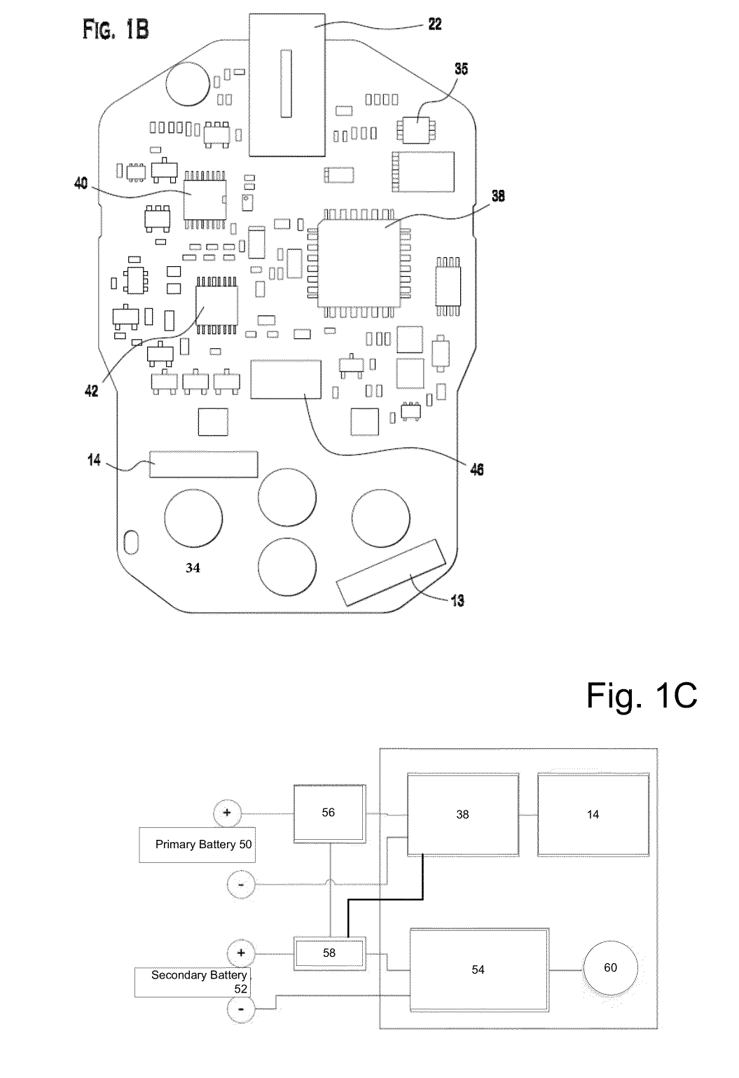

FIG. 1A illustrates a chronic disease management system that includes an analyte data monitoring unit 10 (“DMU”) and a biosensor in the form of an analyte measurement biosensor 24. It is noted that while the biosensor is shown in the form of a test strip to test blood glucose, a continuous glucose monitor can also be utilized as an alternative to the embodiments described herein to provide for physiological data in the form of glucose measurements in physiological fluids.

Analyte monitor or DMU 10 can include a housing 11, user interface buttons (16, 18, and 20), a display 14, a strip port connector 22, and a data port 13, as illustrated in FIG. 1A. User interface buttons (16, 18, and 20) can be configured to allow the entry of data, navigation of menus, and execution of commands. Data can include values representative of analyte concentration, and/or information, which are related to the everyday lifestyle of an individual. Information, which is related to the everyday lifestyle, can include food intake, medication use, occurrence of health check-ups, and general health condition and exercise levels of an individual. Specifically, user interface buttons (16, 18, and 20) include a first user interface button 16, a second user interface button 18, and a third user interface button 20. User interface buttons (16, 18, and 20) include a first marking 17, a second marking 19, and a third marking 21, respectively, which allow a user to navigate through the user interface. Although the buttons are shown as mechanical switches, a touch screen interface with virtual buttons may also be utilized. As represented in FIG. 1A, the DMU is provided with various user-interfaces including the user interface UI to provide for consistency or progressivity feedback to the user's analyte measurements over time.

The electronic components of monitor 10 can be disposed on a circuit board 34 which can be disposed in housing 11. FIG. 1B illustrates (in simplified schematic form) the electronic components disposed on a top surface of circuit board 34. On the top surface, the electronic components include a strip port connector 22, an operational amplifier circuit 35, a microcontroller 38, a display connector, a non-volatile memory 40, a clock 42, and a first wireless module 46. On the bottom surface, the electronic components may include a battery connector (not shown) and a data port 13. Microcontroller 38 can be electrically connected to strip port connector 22, operational amplifier circuit 35, first wireless module 46, display 14, non-volatile memory 40, clock 42, battery, data port 13, and user interface buttons (16, 18, and 20 in FIG. 1A).

Operational amplifier circuit 35 can include two or more operational amplifiers configured to provide a portion of the potentiostat function and the current measurement function. The potentiostat function can refer to the application of a test voltage between at least two electrodes of a biosensor. The current function can refer to the measurement of a test current resulting from the applied test voltage. The current measurement may be performed with a current-to-voltage converter. Microcontroller 38 can be in the form of a mixed signal microprocessor (MSP) such as, for example, the Texas Instrument MSP 430. The TI-MSP 430 can be configured to also perform a portion of the potentiostat function and the current measurement function. In addition, the MSP 430 can also include volatile and non-volatile memory. In another embodiment, many of the electronic components can be integrated with the microcontroller in the form of an application specific integrated circuit (ASIC).

Strip port connector 22 can be configured to form an electrical connection to the biosensor. The display connector can be configured to attach to display 14. Display 14 can be in the form of a liquid crystal display for reporting measured analyte levels, and for facilitating entry of lifestyle related information. Display 14 can optionally include a backlight. Data port 13 can accept a suitable connector attached to a connecting lead, thereby allowing glucose monitor 10 to be linked to an external device such as a personal computer. Data port 13 can be any port that allows for transmission of data such as, for example, a serial, USB, or a parallel port. Clock 42 can be configured to keep current time related to the geographic region in which the user is located and also for measuring time. The DMU can be configured to be electrically connected to a power supply such as, for example, a battery.

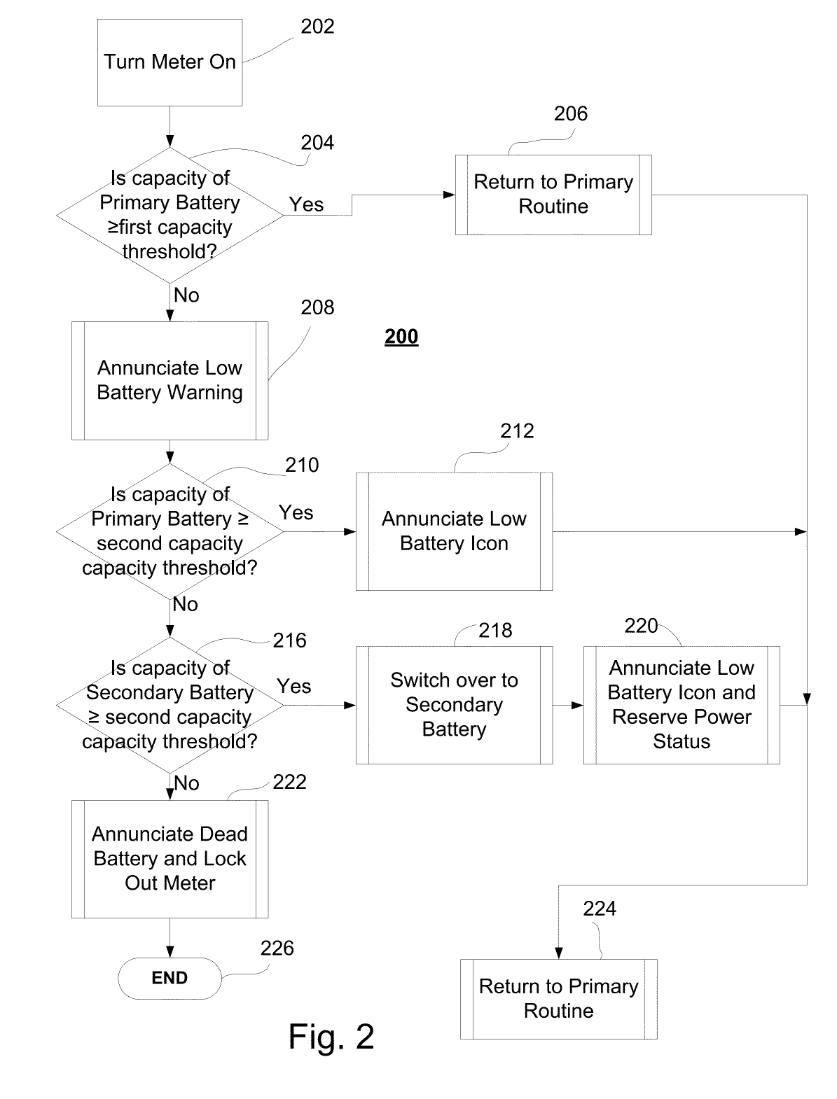

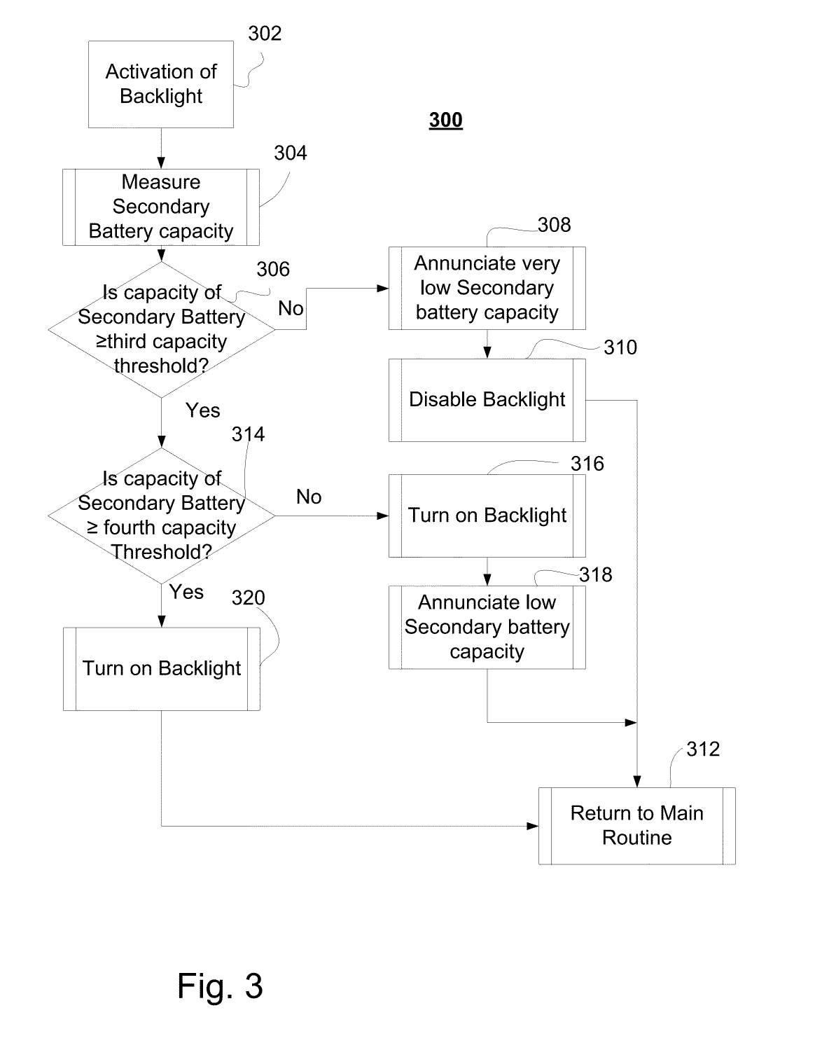

With reference to FIG. 1C, a power supply configuration for the monitor of FIGS. 1A and 1B is shown. In this configuration, the microcontroller 38 is connected to a primary battery 50 for supplying power to the microcontroller 38. A secondary battery 52 is utilized to power a backlight 60 of the display 14 via a back light circuit 54. Under certain circumstances where the primary battery 50 lacks sufficient capacity to power the microprocessor in its intended tasks, the secondary battery 52 can be used in place of (or in addition to) the primary battery 50. When the secondary battery 52 is used to power the microcontroller 38, it is preferred that a reverse charging prevention circuit 58 be interposed between the primary 50 and secondary 52 batteries to prevent the primary battery 50 being charged by the secondary battery 52 and vice versa when the device is powered by the primary battery 50. Typical prevention circuits can be, for example, a diode between the primary and secondary batteries, or for greater circuit protection, three diodes in which one diode is in series with the secondary battery and two diodes are placed in series with the primary battery. In the typical multiple-diode configuration, the diode in series with the secondary battery blocks current from the primary battery into the secondary battery while the two diodes in series with the primary battery are to prevent reverse charging by the secondary battery (with the second diode for redundant protection to the first diode in this series). A switching circuit 58 can be utilized by the microcontroller 38 to switch the power supply from the primary battery 50 to the secondary battery 52 depending on the circumstances determined by a method devised by applicants illustrated here in FIGS. 2 and 3.

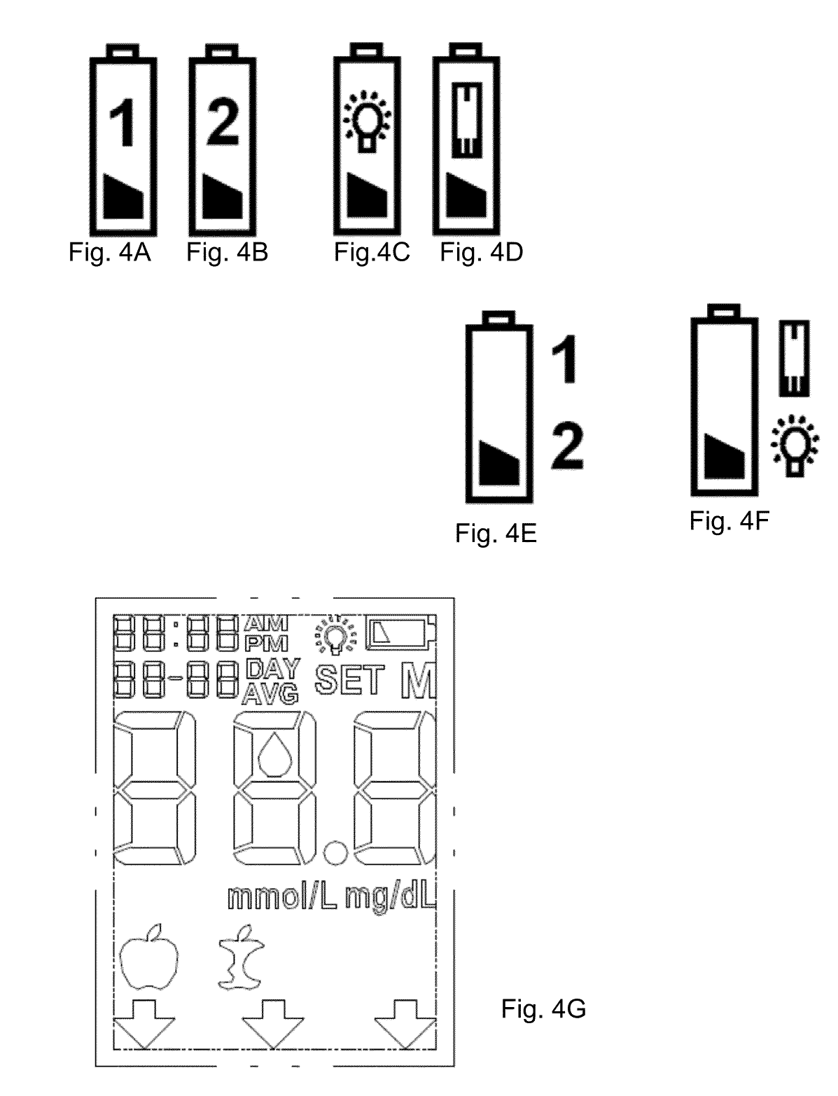

The method to control the switching of main power to backup power can be gleaned from the flow chart of FIGS. 2 and 3. In FIG. 2, the process starts with the monitor being turned on at step 202 such as, for example, during insertion of the analyte strip 24 into the strip receiving port of the monitor. At step 204, the system check to determine if the capacity (e.g., voltage or amperage) of the primary battery 50 is greater than a first battery capacity threshold. If the query at step 204 is true (i.e., capacity of battery 50 is greater than the first capacity threshold) then the process returns to the main routine (step 206 or 224) for measuring the analyte level of the biosensor 24. On the other hand, if the query at step 204 returns a false (i.e., the capacity of the battery 50 is less than the first threshold) then at step 208, a low battery warning is annunciated. Thereafter, the system query at step 210 to determine if the capacity of the primary battery is greater than a second threshold. If query at step 210 returns a true (i.e., battery 50 capacity is greater than the second threshold) then the system annunciates (step 212) a low battery condition in the form of a flashing low battery icon (FIG. 4A, 4D, 4E, or 4F) and the logic proceeds back to the main routine. On the other hand, if the query 210 returns a false, then the system proceeds to query 216 in which the capacity of the secondary battery 52 is checked against the second threshold. If the query 216 returns a true (i.e., yes the secondary battery capacity is greater than the second threshold) then the microcontroller 38 utilizes the switching circuit 58 to switch the power supply from the primary battery 50 to the secondary battery 52 at step 218. At step 220, the device annunciates a low battery condition via, for example, a flashing low battery icon (FIG. 4B, 4C, 4E or 4F) in the display of FIG. 4G. On the other hand, if the query at step 216 returns a false (i.e., no the secondary battery capacity is less than the second threshold) then at step 222, the system annunciates a dead battery and prevents the monitor from being used due to both the primary and secondary batteries being of insufficient capacity to allow the user to conduct analyte measurement tests.

In the event that the user also activates a backlight of the monitor, a method is provided to regulate usage of the secondary battery to allow the secondary battery to remain a viable backup power supply in case the primary battery is exhausted. Specifically, in FIG. 3, the logic 300 is activated whenever the user attempts to activate the backup light 60 (e.g., via a backup light switch or the “OK” button on the monitor) at step 302. At step 304, the capacity of the secondary battery is measured and a query at step 306 determines if the capacity of the secondary battery is greater than a third threshold. If the query at step 306 returns a false or a “no” to the query (i.e., the secondary battery capacity is less than the third threshold) then the logic annunciates in step 308 that the secondary battery has very low capacity for the backlight 60 and thereafter the system disables the backlight 60 in step 310 from being used to conserve the capacity of the secondary battery. On the other hand, if the query at step 306 returns a true (i.e., yes the secondary battery capacity is greater than or equal to the third threshold) then the system checks with query 314 to evaluate whether the capacity of the secondary battery is greater than or equal to a fourth threshold. If the query 314 returns a false (i.e., no the capacity of the secondary 52 is less than the fourth threshold) then the backlight is allowed to be turned on at step 316 but the system annunciates (step 318) a low secondary battery condition such as for example, flashing the backlight icon in 4C, 4F, or the indicia “2” in FIG. 4E. Thereafter the system returns to the main routine for analyte testing. On the other hand, if the query 314 returns a true (i.e., yes the secondary battery capacity is greater than or equal to the fourth threshold) then the backlight 60 is turned on at step 320 but without annunciating a low backlight battery condition. In the preferred embodiments, the first threshold may include a voltage of about 2.6 volts, the second threshold may include a voltage of about 2.5 volts, the third threshold may include a voltage of about 2.0 volts, and the fourth threshold may include a voltage of about 2.1 volts. Alternatively, the first threshold may be from about 80% of at least one of a rated voltage or rated amperage of the primary battery, the second threshold may be of any value of about 60% to about 79% of at least one of a rated voltage or rated amperage of the primary battery. The third threshold may be equal to or less than 65% of at least one of a rated voltage or rated amperage. The fourth threshold may be equal or less than 70% of at least one of a rated voltage or rated amperage. After step 318 or step 320, the logic returns to the main routine for measurements of analytes with the biosensor 24.

Referring back to FIG. 1A, analyte biosensor 24 can be in the form of an electrochemical analyte measurement test strip. Biosensor 24 can include one or more working electrodes and a counter electrode. Biosensor 24 can also include a plurality of electrical contact pads, where each electrode can be in electrical communication with at least one electrical contact pad. Strip port connector 22 can be configured to electrically interface to the electrical contact pads and form electrical communication with the electrodes. Biosensor 24 can include a reagent layer that is disposed over at least one electrode. The reagent layer can include an enzyme and a mediator. Exemplary enzymes suitable for use in the reagent layer include glucose oxidase, glucose dehydrogenase (with pyrroloquinoline quinone co-factor, “PQQ”), and glucose dehydrogenase (with flavin adenine dinucleotide co-factor, “FAD”). An exemplary mediator suitable for use in the reagent layer includes ferricyanide, which in this case is in the oxidized form. The reagent layer can be configured to physically transform glucose into an enzymatic byproduct and in the process generate an amount of reduced mediator (e.g., ferrocyanide) that is proportional to the glucose concentration. The working electrode can then measure a concentration of the reduced mediator in the form of a current. In turn, glucose monitor 10 can convert the current magnitude into a glucose concentration. Details of the preferred biosensor are provided in U.S. Pat. Nos. 6,179,979; 6,193,873; 6,284,125; 6,413,410; 6,475,372; 6,716,577; 6,749,887; 6,863,801; 6,890,421; 7,045,046; 7,291,256; 7,498,132, all of which are incorporated by reference in their entireties herein.

By virtue of the systems and methods described herein, a benefit has been achieved in allowing the portable measurement device to detect or infer when the operational status of a power supply (e.g., weak primary or weak secondary battery) in the device. As well, the patient or user would benefit from the ability to continue analyte testing despite the main battery being exhausted.

Applicants note that various methods described herein can be used to generate software codes using off-the-shelf software development tools such as, for example, machine codes or higher level codes such as Visual Studio 6.0, C or C++ (and its variants). The methods, however, may be transformed into other software languages depending on the requirements and the availability of new software languages for coding the methods. Additionally, the various methods described, once transformed into suitable software codes, may be embodied in any computer-readable storage medium that, when executed by a suitable microprocessor or computer, are operable to carry out the steps described in these methods along with any other necessary steps.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A method of managing power supplies in an analyte measurement device having a microprocessor coupled to a memory, the device including a primary battery and a secondary battery with the primary battery coupled to the microprocessor to power the microprocessor, the method comprising the steps of:
evaluating with the microprocessor whether a measured capacity of the primary battery is greater than a first threshold;
in the event the evaluating step returns an indication that the measured capacity of the primary battery is less than the first threshold, ascertaining whether a capacity of the primary battery is greater than a second threshold;
in the event the ascertaining step returns an indication that the measured capacity of the primary is less than the second threshold, querying whether a measured capacity of the secondary battery is greater than the second threshold; and
in the event the ascertaining step returns an indication that the measured capacity of the secondary battery is greater than the second threshold, then connecting the secondary battery to the microprocessor to power the microprocessor.

2. The method of claim 1, in which the measured capacity of the primary or secondary battery comprises measuring a voltage of the primary or secondary battery.

3. The method of claim 1, in which the connecting comprises disconnecting the primary battery from the microprocessor.

4. The method of claim 1, in which the connecting comprises annunciating that the primary battery is low on power.

5. The method of claim 4, in which the annunciating comprises notifying that the device is on secondary or backup power.

6. The method of claim 1, in which the device is suspended from further operation whenever the ascertaining step returns an indication that the voltage of the secondary battery is less than the secondary threshold.

7. The method of claim 1, in which the secondary battery comprises a battery for a backlight of a display of the measurement device.

8. The method of claim 1, in which the first threshold comprises from about 80% of at least one of a rated voltage or rated amperage of the primary battery.

9. The method of claim 1, in which the second threshold comprises any value of about 60% to about 79% of at least one of a rated voltage or rated amperage of the primary battery.

10. The method of claim 1, further comprising the steps of:
measuring a capacity of the secondary battery;
determining whether a measured capacity of the secondary battery from the measuring step is greater than a third threshold;
in the event the determining step returns an indication that the measured capacity of the secondary battery is less than the third threshold, preventing connection of the backlight to the secondary battery;
in the event the determining step returns an indication that the measured capacity of the secondary battery is greater than the third threshold, evaluating whether the measured capacity of the secondary battery is greater than a fourth threshold; and
in the event the evaluating step returns an indication that the measured capacity of the secondary battery is less than the fourth threshold then annunciating that the capacity of the secondary battery is low.

11. An analyte measurement system comprising:
a biosensor unit that receives a physiological fluid of a use to allow for determination of an analyte in the fluid; and
a portable physiological monitor unit comprising:
a microprocessor in communication with the biosensor unit to receive a plurality of analyte measurements reflective of a health condition of the user, the microprocessor being coupled to a memory and at least one of a primary and secondary batteries; the microprocessor being configured to:
measure a capacity of the primary battery and if the measured capacity is less than a first threshold then evaluate a capacity of the primary battery with respect to a second threshold;
annunciate a low battery condition if there is an indication that the measured capacity of the primary battery is greater than or equal to the second threshold;
evaluate the capacity of the secondary battery with respect to the secondary threshold and if there is an indication that the measured capacity of the primary is less than the second threshold then prevent usage of the unit otherwise if there is an indication that the measured capacity of the secondary battery is greater than the second threshold then the secondary battery is connected to the microprocessor to power the microprocessor;
measure a capacity of the secondary battery;
determine whether a measured capacity of the secondary battery is greater than a third threshold;
prevent a connection of the backlight to the secondary battery if there is an indication that the measured capacity of the secondary battery is less than the third threshold;
evaluate whether the measured capacity of the secondary battery is greater than a fourth threshold if there is an indication that the measured capacity of the secondary battery is greater than the third threshold; and
annunciate that the capacity of the secondary battery is low if there is an indication that the measured capacity of the secondary battery is less than the fourth threshold.

12. The system of claim 11, in which the measured capacity of the primary or secondary battery comprises a voltage of the primary or secondary battery.

13. The system of claim 11, in which connection of the secondary battery to the microprocessor comprises disconnection of the primary battery from the microprocessor.

14. The system of claim 11, further comprising annunciation that the primary battery is low on power.

15. The system of claim 14, in which the annunciation comprises notification that the device is on reserve or backup power.

16. The system of claim 11 in which the device is suspended from further operation whenever the voltage of the secondary battery is less than the secondary threshold.

17. The system of claim 11, in which the secondary battery comprises a battery for a backlight of a display of the measurement device.

18. The system of claim 11 in which the first threshold comprises from about 80% of at least one of a rated voltage or rated amperage of the primary battery.

19. The system of claim 11, in which the second threshold comprises any value of about 60% to about 79% of at least one of a rated voltage or rated amperage of the primary battery.
